(19) United States
(12) Patent Application Publication
(10) Pub. No.: US 2026/0077515 A1
(43) Pub. Date: Mar. 19, 2026

(54) FINGERS FOR GRIPPER ASSEMBLIES

(71) Applicants: Toyota Research Institute, Inc., Los Altos, CA (US); Massachusetts Institute of Technology, Cambridge, MA (US)

(72) Inventors: Jialiang ZHAO, Milpitas, CA (US); Naveen Suresh KUPPUSWAMY, Arlington, MA (US); Edward H. ADELSON, Winchester, MA (US)

(73) Assignees: Toyota Research Institute, Inc., Los Altos, CA (US); Toyota Jidosha Kabushiki Kaisha, Aichi-ken (JP); Massachusetts Institute of Technology, Cambridge, MA (US)

(21) Appl. No.: 19/327,143

(22) Filed: Sep. 12, 2025

Related U.S. Application Data
(60) Provisional application No. 63/694,488, filed on Sep. 13, 2024.

(51) Int. Cl. B25J 19/02; B25J 15/04

(52) U.S. Cl. CPC B25J 19/023; B25J 15/0475; B25J 19/026

(57) ABSTRACT

Disclosed herein are fingers for gripper assemblies. The finger includes a gripper pad. The finger includes a mirror panel facing the gripper pad. The finger includes a first window extending between the gripper pad and the mirror panel. The finger includes a camera oriented to collect image data that includes a reflected view of gripper pad from the mirror and a view through the first window.

### CROSS-REFERENCE TO RELATED APPLICATION

This application claims priority to and all the benefits of co-pending U.S. Provisional Patent Application No. 63/694,488 filed on Sep. 13, 2024, for “ROBUST MULTI-MODAL TACTILE SENSOR FOR CONTACT-RICH MANIPULATION USING TACTILE-DIFFUSION POLICIES,” which is herein incorporated by reference in its entirety.

### TECHNICAL FIELD

The present specification generally relates to fingers for gripper assemblies and, more specifically, fingers for gripper assemblies that include sensors for collecting data to train and/or operate a robot to perform certain tasks.

### BACKGROUND

Gripper assemblies for use with a robot may include multiple sensors, such as cameras. Data collected with the sensors, e.g., when the gripper assembly is attached to an operator controlled hand held unit, can be used to develop a protocol for robot operation to perform certain tasks. Data collected with the sensors, e.g., when the gripper assembly is attached to a robot trained with the protocol, can be used by the robot to operate and perform the certain tasks.

Collecting data for developing protocols for robot operation and for operating the robot to perform tasks that require dexterous manipulation may benefit from more advanced sensor applications than those used with existing gripper assemblies.

### SUMMARY

In one embodiment, a finger for a gripper assembly includes a gripper pad. The finger includes a mirror panel facing the gripper pad. The finger includes a first window extending between the gripper pad and the mirror panel. The finger includes a camera oriented to collect image data that includes a reflected view of gripper pad from the mirror and a view through the first window.

In another embodiment, a finger for a gripper assembly includes a gripper pad. The finger includes a mirror panel facing the gripper pad. The finger includes a camera oriented to collect image data that includes a reflected view of gripper pad from the mirror. The finger includes a first channel. The gripper pad is slidably disposed in the first channel to provide for removal and replacement of the gripper pad.

In another embodiment, a gripper assembly for use with a robot includes a first finger and a second finger. The first finger and the second finger are movable to open and closed positions. The first finger includes a gripper pad. The first finger includes a mirror panel facing the gripper pad. The first finger includes a first window extending between the gripper pad and the mirror panel. The first finger includes a camera oriented to collect image data that includes a reflected view of gripper pad from the mirror and a view through the first window.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts perspective view of a gripper assembly having a first finger and a second finger, according to one or more embodiments shown and described herein;

FIG. 2 schematically depicts image data captured by a camera of the first finger, according to one or more embodiments shown and described herein;

FIG. 3 schematically depicts a side cross-section view of the first finger, according to one or more embodiments shown and described herein;

FIG. 4 schematically depicts a front cross-section view of the first finger, according to one or more embodiments shown and described herein;

FIG. 5 schematically depicts a top view of the first finger, according to one or more embodiments shown and described herein; and

FIG. 6 schematically depicts the first finger with a gripper pad partially removed, according to one or more embodiments shown and described herein.

### DETAILED DESCRIPTION

Embodiments described herein are directed to a gripper assembly that includes first and second fingers for grasping objects and a camera for collecting data to train or operate a robot that includes the gripper assembly.

The first finger includes a gripping pad, windows, and a mirror that permit the camera to capture image data that includes the gripping pad and areas that are peripheral to the first finger. Various embodiments of the first finger and the operation of the gripper assembly are described in more detail herein. Whenever possible, the same reference numerals will be used throughout the drawings to refer to the same or like parts.

Directional terms as used herein-for example forward, up, down, right, left, front, back, top, bottom-are made only with reference to the figures as drawn and are not intended to imply absolute orientation.

Values can be expressed herein as being “about” one particular value. When such a value is expressed, one embodiment includes the particular value. Similarly, by use of the antecedent “about,” it will be understood that the particular value is an approximation that includes values similar to the particular value.

As used herein, the singular forms “a,” “an” and “the” include plural referents unless the context clearly dictates otherwise. Thus, for example, reference to “a” component includes aspects having two or more such components, unless the context clearly indicates otherwise.

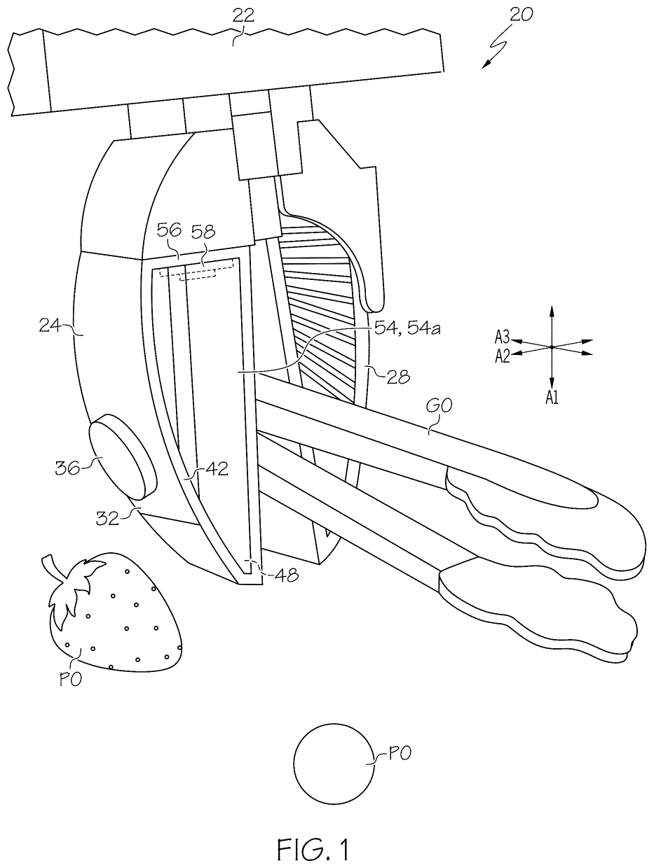

Referring now to FIG. 1, a gripper assembly 20 is illustrated according to one or more embodiments described herein. The gripper assembly 20 may generally include a plurality of fingers, e.g., a first finger 24 and a second finger 28, movable to open and closed positions. Moving the fingers to the open positions includes moving one or more of the fingers away from other of the fingers, e.g., to release an object GO grasped by the gripper assembly 20. In embodiments, moving the fingers to the open positions may include moving the first finger 24 away from the second finger 28 and/or moving the second finger 28 away from the first finger 24. Moving the fingers to the closed positions includes moving one or more of the fingers toward other of the fingers, e.g., to grasp an object GO. In embodiments, moving the fingers to the closed positions may include moving the first finger 24 toward the second finger 28 and/or moving the second finger 28 toward the first finger 24. Although the gripper assembly 20 shown in FIG. 1 includes two fingers, i.e., the first finger 24 and the second finger 28, it is to be understood that the gripper assembly 20 may include additional fingers, e.g., a third finger, a fourth finger, etc.

The gripper assembly 20 may be used with a robot 22. For example, the gripper assembly 20 may be connected to a user interface that allows an operator to control the position and orientation of the gripper assembly 20 and to control actuation of the fingers to the open positions and the closed positions. The user interface may be, for example and without limitation, a handheld unit to which the gripper assembly 20 is attached. In such example, data collected by sensors of the gripper assembly 20 may be used to develop a protocol for robot operation, e.g., to mimic control of the gripper assembly 20 as dictated by an operator using the user interface. As another example, the gripper assembly 20 may be connected to the robot 22 The robot 22 may be a six-axis robot or the like that autonomously controls the position and orientation of the gripper assembly 20 and autonomously controls actuation of the fingers to the open positions and the closed positions, e.g., based on data collected by the sensors of the gripper assembly 20 and according to the protocol for robot operation developed with the gripper assembly 20 connected to the user interface. The sensors of the gripper assembly 20 may include one or more cameras, microphones, pressure sensors, etc., including a camera 58 and a microphone 36 of the first finger 24 discussed herein.

In embodiments, the first finger 24 includes a body 32. The body 32 may support, and/or be comprised of, other components of the first finger 24. For example, the body 32 may include a mirror panel 42, one or more windows 54, and a base wall 56. The mirror panel 42 and the windows 54 may extend away from the base wall 56, e.g., generally along a first axis A1. The mirror panel 42 includes a mirrored reflective surface for directing light toward the camera 58. The mirrored reflective surface is on an inner surface of mirror panel 42, e.g., facing a gripper pad 48 of the first finger 24.

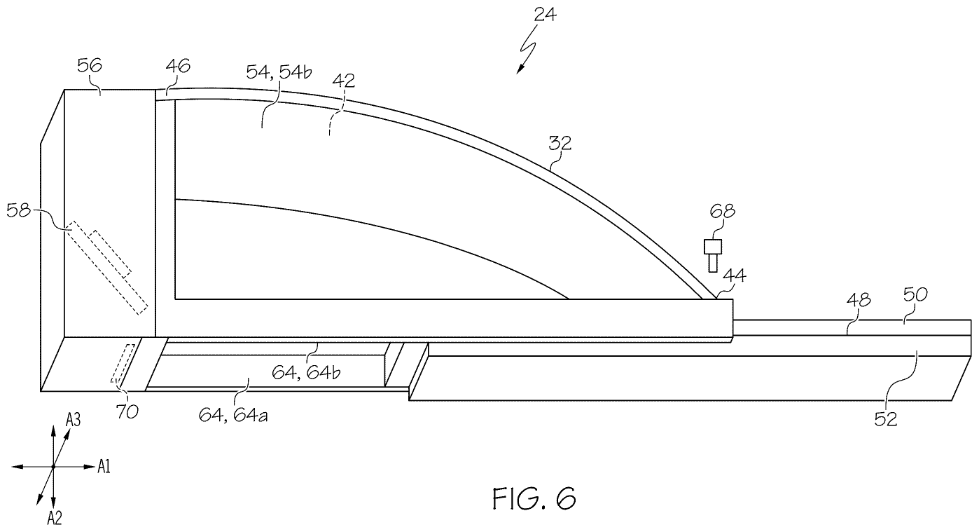

The gripper pad 48 provides a tactile surface that contacts an object GO grasped by the gripper assembly 20. In embodiments, the gripper pad 48 includes a rigid layer 50 and a deformable layer 52 (see FIG. 6). The rigid layer 50 and the deformable layer 52 are, in embodiments, at least partially, transparent. The gripper pad 48 is oriented such that the rigid layer 50 is between the mirror panel 42 and the deformable layer 52. The deformable layer 52 contacts the object GO grasped by the gripper assembly 20. The deformable layer 52 may include, for example and without limitation, a VBH elastomer such as clear 3M VHB double-sided tape with an outfacing surface covered with 325 mesh (i.e. 45 μm) reflective aluminum powder, a silicone elastomer such as Silicones Inc. XP-565 silicone rubber with PRINT-ON gray silicone ink on its outfacing side, or the like. The rigid layer 50 may include, for example and without limitation, a clear acrylic plate or the like.

In embodiments, the first finger 24 includes a plurality of lights 70 (see FIG. 6), such as light emitting diodes (LEDs) or the like, configured to illuminate the gripper pad 48. For example and without limitation, a shorter side of the rigid layer 50 may be illuminated with blue LEDs (450 nm wavelength). Longer sides of the rigid layer 50 may be painted with pink and green fluorescent paint, such as Liquitex BASICS Fluorescent Pink and Fluorescent Green. The two colors of fluorescent paint absorb energy from the blue light, which has a shorter wavelength, then emit the energy as longer wavelength light in pink and green. A transparent yellow vinyl filter may be glued to the rigid layer 50 to reduce an amount of blue light that reaches the camera 58. Additionally and/or alternately, multi-colored LEDs may be used.

The first finger 24 includes the camera 58. The camera 58 detects light and generates image data based on the detected light. The camera 58 may be an RGB camera that captures visible light to produce images in full color. The camera 58 includes an image sensor that turns light into discrete signals. For example, the camera 58 may include a charge-coupled device (CCD) or a complementary metal-oxide-semiconductor (CMOS) based image sensor. The camera 58 may include a color filter array (such as a Bayer filter) over the image sensor to isolate red, green, and blue light, and may combine such data to create a detailed, full-color image. The camera 58 may include one or more lenses, mirrors and/or other optical structures that focus light on the image sensor. The camera 58 may have a 4:3 aspect ratio with a diagonal field of view of about 120 degrees, or any suitable aspect ratio and field of view.

In embodiments, the camera 58 is supported by, e.g., fixed to, the base wall 56 of the first finger 24. The camera 58 may be disposed in a cavity (not numbered) defined by the first finger 24. The cavity may be defined by one or more of the gripper pad 48, the mirror panel 42, the windows 54 and/or the base wall 56. In other words, the cavity may be at least partially enclosed by one or more of the gripper pad 48, the mirror panel 42, the windows 54 and/or the base wall 56.

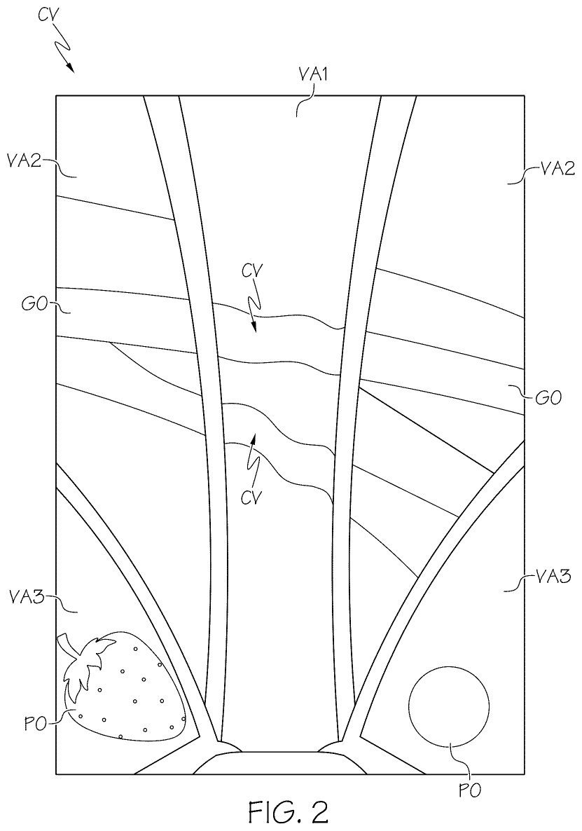

The camera 58 is oriented to collect image data that includes a reflected view of gripper pad 48 from the mirror. For example, and with reference to FIG. 2, the image data collected by the camera 58 may include a first view area VA1. The first view area VA1 includes an image of the gripper pad 48 reflected to the camera 58 with the mirror panel 42. The image of the gripper pad 48 in the first view area VA1 permits the camera 58 to function as a tactile sensor by detecting color variations CV on the gripper pad 48 that are produced when the gripper pad 48 grasps an object GO. The color variations CV may indicate a contact area between the gripper pad 48 and the object GO. The color variations CV may indicate an amount of force applied to the object by the gripper pad 48 at the contact area. The color variations CV may be produced by deformation of the gripper pad 48 that are produced when the gripper pad 48 grasps an object GO and reflects light from the lights of the first finger 24 and/or from the fluorescent paint.

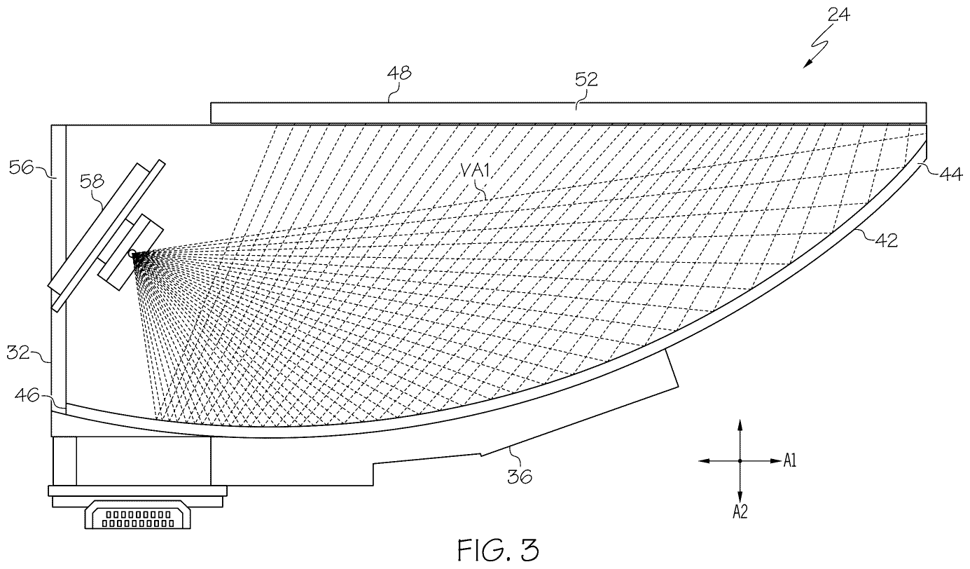

With refence to FIG. 3, a cross-section of the first finger 24 taken along the first axis A1 and a second axis A2 is illustrated. The first axis A1 is perpendicular to the second axis A2. As shown in FIG. 3, the mirror panel 42 faces the gripper pad 48, e.g., such that the field of view of the camera 58 that includes the first view area VA1 is directed by the mirrored reflective surface of the mirror panel 42 to the gripper pad 48. One distal edge 44 of the mirror panel 42 may generally abut the gripper pad 48 and an opposite distal edge 46 of the mirror panel 42 may be spaced from the gripper pad 48, e.g., along the second axis A2. The base wall 56 of the first finger 24 may be disposed between the distal edge 46 of the mirror panel 42 and the gripper pad 48.

In embodiments, the mirror panel 42 is arcuate. For example, the mirror panel 42 may have a generally continuous curvature from one distal end 44 to the other distal end 46, i.e., without any sharp angles or straight sections. Alternately, the mirror panel 42 may be generally linear or include multiple generally linear segments in series and oriented at progressively increasing angles. The curvature and placement of the mirror panel 42 may be configured so that generally an entire inner surface of the gripper pad 48 is visible in the first view area VA1 (FIG. 2) of the field of view of the camera 58. The curvature and placement of the mirror panel 42 may be configured such that the camera 58 has a generally orthogonal view of inner surface of the gripper pad 48. The curvature and placement of the mirror panel 42 may be configured such that light from numerous directions is detected by the camera 58 to provide increased resolution regarding depth information obtained from color variation CV detected on the gripper pad 48.

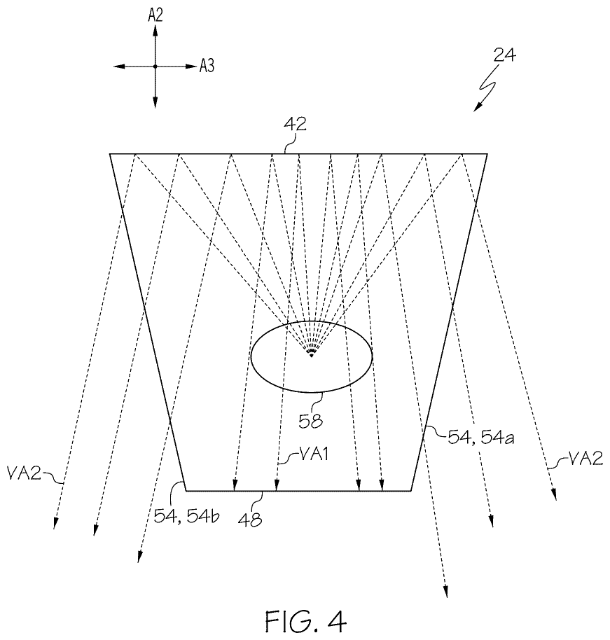

In embodiments, the camera 58 is oriented to collect image data that includes a view through at least one of the windows 54, e.g., through a first window 54a and/or a second window 54b. The view though the first window 54a and/or the second window 54b may include image data generated from light reflected by the mirror panel 42. For example, and again with reference to FIG. 2, the image data collected by the camera 58 may include a second view area VA2. The second view area VA2 includes an image of an area generally adjacent and below the first finger 24, e.g., in a direction away from the mirror panel 42 toward the gripper pad 48 along the second axis A2. The second view area VA2 permits the camera 58 to detect peripheral portions of a grasped object GO (FIGS. 1 and 2), e.g., below and to a right or left adjacent to the first finger 24 (e.g. along a third axis A3 that is perpendicular to the first axis A1 and the second axis A2 and shown in FIG. 4).

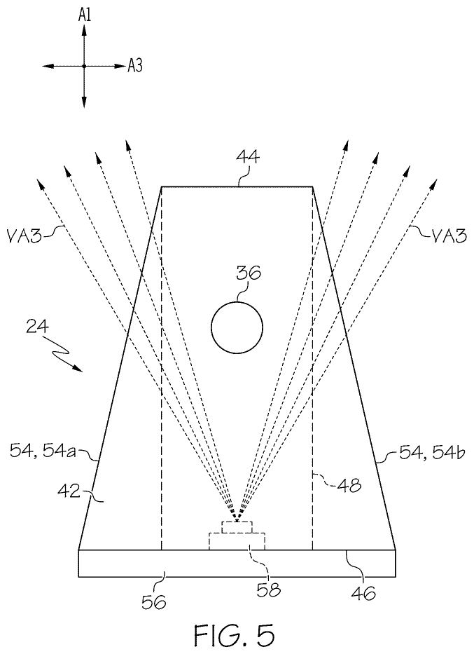

Turning now to FIG. 4, a cross-section of the first finger 24 taken along the second axis A2 and the third axis A3 is illustrated. The second axis A2 is perpendicular to the third axis A3. The third axis A3 is perpendicular to the first axis A1 (see FIG. 5). As shown in FIG. 4, the field of view of the camera 58 that includes the second view area VA2 is directed by the mirrored reflective surface of the of the mirror panel 42 through the first window 54a and the second window 54b, e.g., to the right and left of the gripper pad 48 relative to the third axis A3 and below the gripper pad 48 along the second axis A2.

In embodiments, to provide the second view area VA2, the first window 54a extends between the gripper pad 48 and the mirror panel 42. For example and without limitation, the first window 54a may extend from the gripper pad 48 to the mirror panel 42. Similarly, the second window 54b extends between the gripper pad 48 and the mirror panel 42, e.g., from the gripper pad 48 to the mirror panel 42. The windows 54 include a transparent material, such as transparent acrylic or the like. The windows 54 may be generally planar, or other suitable shape.

The first window 54a and/or the second window 54b extend obliquely relative to the gripper pad 48. In other words, the first window 54a and/or the second window 54b extend neither parallel nor perpendicular relative to the gripper pad 48. The gripper pad 48 is disposed between the first window 54a and the second window 54b, e.g., along the third axis A3. The mirror panel 42 is disposed between the first window 54a and the second window 54b, e.g., along the third axis A3. A width of the mirror panel 42, e.g., along the third axis A3, is greater than a width of the gripper pad 48. e.g., along the third axis A3.

The view though the first window 54a and/or the second window 54b may include image data generated from light not reflected by the mirror panel 42. For example, and again with reference to FIG. 2, the image data collected by the camera 58 may include a third view area VA3. The third view area VA3 includes an image of a peripheral area generally adjacent and forward of the first finger 24, e.g., in a direction away from the base wall 56 along the first axis A1. The third view area VA3 permits the camera 58 to see objects PO that are peripheral, e.g., forward and to a right or left (i.e. along the third axis A3) to the first finger 24.

Turning now to FIG. 5, a top view of the first finger 24 is illustrated. As shown in FIG. 5, the field of view of the camera 58 that includes the third view area VA3 extends through the first window 54a and the second window 54b, e.g., to the right and left of the gripper pad 48 relative to the third axis A3 and forward of the gripper pad 48 along the first axis A1. The third view area VA3 may be detected by the camera 58 without being reflected by the mirrored reflective surface of the mirror panel 42.

In embodiments, to provide the third view area VA3, the first window 54a extends along the mirror panel 42. For example and without limitation, the first window 54a may extend from the distal edge 44 of the mirror panel 42 at the base wall 56 to the distal edge 46 of the mirror panel 42 spaced from the base wall 56. Similarly, the second window 54b extends along the mirror panel 42, e.g., from one distal edge 44 of the mirror panel 42 to the other distal edge 46 of the mirror panel 42. A width of the distal edge 46 of the mirror panel 42 at the base wall 56, e.g., along the third axis A3, may be greater than a width of the distal edge 44 of the mirror panel 42 spaced from the base wall 56, e.g., along the third axis A3. In other words, the width of the mirror panel 42 along the third axis A3 may narrow as the mirror panel 42 extends from the base wall 56. The width of the gripper pad 48 along the third axis A3 may be generally equal to the width of the distal edge 44 of the mirror panel 42 spaced from the base wall 56.

With reference to FIG. 6, the first finger 24 may include one or more channels 64 64, e.g., a first channel 64a and a second channel 64b. The channels 64 may be at bottom edges of windows 54 and elongated generally parallel to the first axis A1. The windows 54 may extend between the channel 64 and the mirror panel 42, e.g., from the channels 64 to the mirror panel 42 along the second axis A2. The gripper pad 48 may be disposed between the channels 64, e.g., along the third axis A3. The gripper pad 48 may be slidably disposed in the first channel 64a and/or the second channel 64b to provide for removal and replacement of the gripper pad 48. For example, as shown in FIG. 6, the gripper pad 48 may be slid toward or away from base wall 56 to remove or install the gripper pad 48, respectively. A fastener may be included to secure the gripper pad 48 in the first channel 64a and the second channel 64b. The fastener may be a screw 68, or any suitable structure. The fastener may be engaged with the gripper pad 48 after the gripper pad 48 is slid to an installed position. The installed position is shown, for example, in FIGS. 1 and 3.

Returning to FIG. 1, the first finger 24 may include the microphone 36. The microphone 36 may be a piezoelectric contact microphone or other suitable structure for detecting vibrations and generator an electrical signal based on the detected vibrations. The microphone 36 may be fixed to an outer surface of the mirror panel 42, e.g., opposite the mirrored reflective surface. The microphone 36 may detect vibrations of the first finger 24 that can occur when grasping an object GO.

Although shown as a conventional finger in FIG. 1, it is to be understood that the second finger 28 could include the various features and structures described herein for the first finger 24.

Tactile information obtained from the first view area VA1 with the camera 58, peripheral vision information obtained from the second view area VA2 and the third view area VA3 with the camera 58, and vibration information obtained with the microphone 36 may be synchronously captured, e.g., for training or operation of a robot. Capturing the first view area VA1, the second view area VA2, and the third view area VA3 with the camera 58 provides relatively lower cost of hardware, e.g., compared to using multiple cameras.

From the above, it is to be appreciated that defined herein is a finger for a gripper assembly that includes sensors for collecting data to data to train and/or operate a robot to perform certain tasks and that provides robust data collection for dexterous manipulation of an object.

It is noted that the term “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A finger for a gripper assembly, the finger comprising:
a gripper pad;
a mirror panel facing the gripper pad;
a first window extending between the gripper pad and the mirror panel; and
a camera oriented to collect image data that includes a reflected view of the gripper pad from the mirror and a view through the first window.

2. The finger of claim 1, further comprising a second window extending between the gripper pad and the mirror panel, the gripper pad and the mirror panel disposed between the first window and the second window.

3. The finger of claim 2, wherein the gripper pad, the mirror panel, the first window and the second window define a cavity, and wherein the camera is disposed in the cavity.

4. The finger of claim 1, wherein the view though the first window includes image data generated from light reflected by the mirror.

5. The finger of claim 4, wherein the view though the first window includes image data generated from light not reflected by the mirror.

6. The finger of claim 1, wherein a width of the mirror panel is greater than a width of the gripper pad.

7. The finger of claim 1, wherein the first window extends obliquely relative to the gripper pad.

8. The finger of claim 1, wherein the mirror panel is arcuate.

9. The finger of claim 1, further comprising a channel, and wherein the gripper pad is slidably disposed in the channel.

10. The finger of claim 1, further comprising a microphone.

11. A finger for a gripper assembly, the finger comprising:
a gripper pad;
a mirror panel facing the gripper pad;
a camera oriented to collect image data that includes a reflected view of gripper pad from the mirror; and
a first channel, the gripper pad being slidably disposed in the first channel to provide for removal and replacement of the gripper pad.

12. The finger of claim 11, further comprising a fastener securing the gripper pad in the first channel.

13. The finger of claim 11, further comprising a second channel, the gripper pad being slidably disposed in the second channel.

14. The finger of claim 11, further comprising a first window extending between the channel and the mirror panel.

15. A gripper assembly for use with a robot, the gripper assembly comprising:
a first finger and a second finger movable to open and closed positions, the first finger including:
a gripper pad;
a mirror panel facing the gripper pad;
a first window extending between the gripper pad and the mirror panel; and
a camera oriented to collect image data that includes a reflected view of gripper pad from the mirror and a view through the first window.

16. The gripper assembly of claim 15, wherein the first finger includes a second window extending between the gripper pad and the mirror panel, the gripper pad and the mirror panel disposed between the first window and the second window.

17. The gripper assembly of claim 15, wherein the view though the first window includes image data generated from light reflected by the mirror and includes image data generated from light not reflected by the mirror.

18. The gripper assembly of claim 15, wherein a width of the mirror panel is greater than a width of the gripper pad.

19. The gripper assembly of claim 15, wherein the first window extends obliquely relative to the gripper pad.

20. The gripper assembly of claim 11, wherein the first finger includes a channel, and wherein the gripper pad is slidably disposed in the channel.
